(19) United States
(12) Patent Application Publication
(10) Pub. No.: US 2021/0326950 A1
(43) Pub. Date: Oct. 21, 2021

(54) SUPPLY CHAIN MANAGEMENT SYSTEM AND METHOD

(71) Applicant: International Compliance Workshop Limited, Kowloon (HK)

(72) Inventors: Chi Him Lam, Kowloon (HK); Ka Yan Bonnie Lui, Kowloon (HK); Shun Chi Tam, Kowloon (HK)

(21) Appl. No.: 17/258,928

(22) PCT Filed: Aug. 3, 2018
(86) PCT No.: PCT/CN2018/098558

§ 371 Date: Jan. 8, 2021

(51) Int. Cl. G06Q 30/06; G06Q 10/08; G06Q 30/00

(52) U.S. Cl. CPC G06Q 30/0605; G06Q 30/0609; G06Q 30/0633; G06Q 10/0833; G06Q 30/018; G06Q 10/0875; G06Q 10/0838

(57) ABSTRACT

A system and method of managing a supply chain between a buyer device associated with a buyer and a supplier device associated with a supplier, wherein the method is executed by a supply chain platform comprising one or more hardware components, the method comprising the steps of receiving an order defining one or more order information from a buyer device, wherein the order information define one or more products and one or more quality standards, presenting one or more available suppliers and supplier information associated with each supplier, the supplier information including at a supplier location and quality assurance certifications associated with the supplier, providing the order, including the order information, to a selected supplier device, receiving an order confirmation from the supplier device, providing the order confirmation to the buyer device, creating and storing a transaction record within a transaction record database, following receipt of the order confirmation from the supplier device, the transaction record comprising buyer information, seller information and the order information, receiving shipping information from the supplier device, providing shipping information to the buyer device, wherein the shipping information comprises a shipping date, a shipping itinerary and shipping provider.

### TECHNICAL FIELD

The present disclosure relates to supply chain management system. In particular, but not limited to, a supply chain management system to allow two or more parties to interact with each other. The present disclosure also relates to a supply chain management method.

### BACKGROUND

Supply chains are integral to modern commerce structures and systems. A supply chain is a network between multiple parties e.g. buyers and sellers to produce and distribute a product e.g. goods and/or services. The supply chain represents the steps it takes to get the product or service to the customer. Supply chain management is a necessary element of commerce. Supply chain management is the management of flow of goods and services between buyers and sellers.

The conventional distribution of goods e.g. products and/or services includes a number of inefficiencies that can result in higher retail prices, waste of resources, increase costs and time for production and delivery of said goods. Effective logistics management i.e. supply chain management has been recognised as an element in improving the profitability and efficiency of firms.

### SUMMARY OF THE INVENTION

It is an object of the present invention to provide an improved supply chain management system, or at least provide the public with a useful alternative.

Other objects of the invention (or inventions) may become apparent from the following description and drawings, which is given by way of example only.

In one form the present disclosure relates to a supply chain management system and a method for managing a supply chain.

In accordance with a first aspect the present invention relates to a method of managing a supply chain between a buyer device associated with a buyer and a supplier device associated with a supplier, wherein the method is executed by a supply chain platform comprising one or more hardware components, the method comprising the steps of:

receiving an order defining one or more order information from a buyer device, wherein the order information define one or more products and one or more quality standards,

presenting one or more available suppliers and supplier information associated with each supplier, the supplier information including at a supplier location and quality assurance certifications associated with the supplier,

providing the order, including the order information, to a selected supplier device,

receiving an order confirmation from the supplier device,

providing the order confirmation to the buyer device,

creating and storing a transaction record within a transaction record database, following receipt of the order confirmation from the supplier device, the transaction record comprising buyer information, seller information and the order information,

receiving shipping information from the supplier device,

providing shipping information to the buyer device, wherein the shipping information comprises a shipping date, a shipping itinerary and shipping provider.

In an embodiment the order information comprises a plurality of parameter, the parameters including one or more of:

a desired delivery date;

cost of production;

cost of shipping;

one or more standards the product is required to adhere to;

quantity of product required, and;

one or more predefined milestones.

In an embodiment the supplier information comprises a plurality of parameters including one or more of:

quality assurance certifications;

location;

types of products supplied by the supplier;

production equipment details

types of manufacturing processes that can be performed by the supplier.

In an embodiment the method comprises the additional step of:

identifying one or more available suppliers from a supplier database based on the order information.

In an embodiment the step of identifying the one or more available suppliers are identified by comparing parameters of the supplier information associated with each supplier with one or more parameters of the order information, and the one or more suppliers being identified if two or more supplier information parameters correspond to two or more parameters of the order information.

In an embodiment the method the step of presenting one or more available suppliers are presented in an order based on the amount of matches between one or more parameters of the supplier information and one or more parameters of the order information.

In an embodiment the method comprises the additional step of receiving quality information associated with a specific product being supplied by the supplier and wherein the quality information comprises the compliance to the quality standards defined in the order information.

In an embodiment the method comprises the additional step of storing compliance to the quality standards associated with each product within a product certification database.

In an embodiment the method comprises the additional step of presenting the quality information to the buyer device such that the buyer can determine if the supplier has adhered to defined quality standards.

In an embodiment the method comprises the additional steps of:

receiving a status information from the supplier device at regular time intervals, wherein the status information is related to a product defined within the order details

processing the status information to determine if any of the one or more predefined milestones has been achieved,

generating information that comprises data related to any of the one or more predefined milestones has being achieved by the supplier,

providing the milestone information to the buyer device.

In an embodiment the method comprises the additional steps of:

receiving details of an independent tester and a test request, the test request defining one or more standards that a product from a supplier should adhere to,

providing the test request to an independent tester device associated with the independent tester,

providing the supplier device with details of the independent tester.

In an embodiment the method comprises the additional steps of processing the test request, and providing a list of independent testers to the buyer device wherein the list of independent testers is compiled from a database of independent testers.

In an embodiment the independent testers selected for the list are selected based on if the independent tests can test for one or more standards defined in the test request.

In an embodiment the method comprises the additional steps of receiving test results from the supplier device following testing executed by the independent tester and providing the test results to the buyer device.

In an embodiment the method comprises the additional step of creating a compliance profile for each supplier, wherein the compliance profile comprises one or more compliance certificates.

In accordance with a further embodiment the present invention relates to a supply chain management system comprising:

a supply chain platform including at least one hardware processor unit and a memory unit, the processor unit and the memory unit arranged in electrical communication with each other,

the supply chain platform configured to electronically communicate with one or more buyer devices and one or more supplier devices,

a transaction record database adapted to store transaction records, a shipping information database adapted to store shipping information,

a supplier database arranged to store supplier information associated with a supplier,

the supply chain platform further configured to:

receive an order defining order information from the buyer device, wherein the order information defines one or more products to be supplied, and one or more quality standards,

present one or more available suppliers and the supplier information associated with each supplier on the buyer device, wherein the supplier information includes a supplier location and quality assurance certifications associated with the supplier,

receive a supplier selection from the buyer device,

provide the order, including the order information, to a selected supplier device,

receive an order confirmation from the supplier device, the order confirmation denoting the supplier can fill the order,

provide the order confirmation to the buyer device,

create and store a transaction record within the transaction record database, following receipt of the order confirmation from the supplier device, the transaction record comprising buyer information, seller information and the order information,

receive shipping information from the supplier device, and;

provide shipping information to the buyer device, wherein the shipping information comprises a shipping date, a shipping itinerary and shipping provider.

In an embodiment the order information comprises a plurality of parameter, the parameters including one or more of:

a desired delivery date;

cost of production;

cost of shipping;

one or more standards the product is required to adhere to;

quantity of product required, and;

one or more predefined milestones.

In an embodiment the supplier information comprises a plurality of parameters including one or more of:

quality assurance certifications;

location;

types of products supplied by the supplier;

production equipment details

types of manufacturing processes that can be performed by the supplier.

In an embodiment the supply chain platform is further configured to identify one or more available suppliers from the supplier database based on comparing the order information the supplier information associated with each supplier.

In an embodiment the supply chain platform is configured to identify the one or more available suppliers by comparing parameters of the supplier information associated with each supplier with one or more parameters of the order information, and the one or more suppliers being identified if two or more supplier information parameters correspond to two or more parameters of the order information.

In an embodiment the supply chain platform is configured to present the one or more available suppliers in an order based on the amount of matches between one or more parameters of the supplier information and one or more parameters of the order information.

In an embodiment the supply chain platform is configured to receive quality information associated with a specific product being supplied by the supplier and wherein the quality information comprises at least the compliance to the quality standards defined in the order information.

In an embodiment the supply chain management system further comprises a product certification database adapted to store compliance to quality standards, wherein the supply chain platform is configured to store compliance to the quality standards associated with each product supplied by the supplier within the product certification database.

In an embodiment the supply chain platform is further configured to present the quality information to the buyer device such that the buyer can determine if the supplier has adhered to defined quality standards.

In an embodiment the supply chain platform further configured to:

receive a status information from the supplier device at regular time intervals, wherein the status information is related to a product defined within the order details

process the status information to determine if any of the one or more predefined milestones has been achieved,

generate milestone information that comprises data related to any of the one or more predefined milestones has being achieved by the supplier,

provide the milestone information to the buyer device.

In an embodiment the system comprises an independent tester database, the independent tester database storing details of one or more independent testers and details of the tests the independent testers are qualified to perform,

the supply chain platform comprises a quality assurance engine arranged in electronic communication with the processor unit and/or the memory unit,

the supply chain platform or the quality assurance engine being configured to:

receive details of an independent tester and a test request, the test request defining one or more standards that a product from a supplier should adhere to,

provide the test request to an independent tester device associated with the independent tester,

provide the supplier device with details of the independent tester.

In an embodiment the supply chain platform or the quality assurance engine configured to process the test request, and provide a list of independent testers to the buyer device wherein the list of independent testers is compiled from the database of independent testers.

In an embodiment the supply chain platform or quality assurance engine configured to select independent testers for the list are selected based on if the independent tests can test for one or more standards defined in the test request.

In an embodiment the supply chain platform or quality assurance engine being configured to receive test results from the supplier device following testing executed by the independent tester and provide the test results to the buyer device.

In an embodiment the supply chain platform is configured to create a compliance profile for each supplier, wherein the compliance profile comprises one or more compliance certificates.

In an embodiment the supply chain platform comprises a communication unit, the communication unit is arranged in electronic communication with at least the processor unit such that processor unit controls operation of the communication unit based on a computer readable instructions executed by the processor unit and the communication unit being configured to send and receive electronic messages over a wireless communication network.

In an embodiment the supply chain platform comprises a server including the at least one hardware processor unit and the memory unit, wherein supply chain platform is configured to wirelessly communicate with the buyer devices and supplier devices via a suitable wireless communication network, and wherein the supply chain platform is arranged in a server client relationship with the buyer devices and the supplier devices, such that the supply chain platform functions as the server.

In an embodiment the supply chain platform is implemented in a cloud computing system, the cloud computing system comprising a plurality of interconnected servers or computing devices.

In an embodiment the supply chain platform further comprises;

a shipment engine arranged in electronic communication with the processor unit and/or the memory unit,

the shipment engine configured to process shipping information and store shipping information in a shipping database, the shipment engine further configured to communicate with a shipping company and track the location of a product being shipped, and the shipment engine configured to provide the location of the product to the user device at predetermined time intervals.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

As used herein the term “buyer” or “buyers” (or variations thereof) denotes an upstream party in a supply chain, such as for example retailers, importers, distributors, customers etc.

As used herein the term “supplier” or “suppliers” (or variations thereof) denotes a downstream party in a supply chain, such as for example vendors, manufacturers, factories, raw material suppliers etc.

As used herein the term quality standard or quality assurance standard (or variations thereof) denotes either quality and/or regulatory standards that are defined by a regulatory legislation or quality best practice.

As used herein the term ‘and/or’ means ‘and’ or ‘or’, or where the context allows both.

As used herein “(s)” following a noun means the plural and/or singular forms of the noun.

The invention consists in the foregoing and also envisages constructions of which the following gives examples only. In the following description like numbers denote like features.

In the following description, specific details are given to provide a thorough understanding of the embodiments. However, it will be understood by one of ordinary skill in the art that the embodiments may be practiced without these specific details. For example, software modules, functions, circuits, etc., may be shown in block diagrams in order not to obscure the embodiments in unnecessary detail. In other instances, well-known modules, structures and techniques may not be shown in detail in order not to obscure the embodiments.

Also, it is noted that at least some embodiments may be described as a method (i.e. process) that is depicted as a flowchart, a flow diagram, a structure diagram, or a block diagram. Although a flowchart may describe the operations as a sequential method, many of the operations can be performed in parallel or concurrently. In addition, the order of the operations may be rearranged. A method (i.e. process) is terminated when its operations are completed. A method (i.e. process) may correspond to a method, a function, a procedure, a subroutine, a subprogram, etc., in a computer program. When a process corresponds to a function, its termination corresponds to a return of the function to the calling function or a main function.

Aspects of the systems and methods described below may be operable on any type of general purpose computer system or computing device, including, but not limited to, a desktop, laptop, notebook, tablet or mobile device. The term “mobile device” includes, but is not limited to, a wireless device, a mobile phone, a smart phone, a mobile communication device, a user communication device, personal digital assistant, mobile hand-held computer, a laptop computer, an electronic book reader and reading devices capable of reading electronic contents and/or other types of mobile devices typically carried by individuals and/or having some form of communication capabilities (e.g., wireless, infrared, short-range radio, etc.) or wearable devices comprising a computer or computing device to allow the wearable devices to store and execute/process computer readable instructions.

In this specification, the word “comprising” and its variations, such as “comprises”, has its usual meaning in accordance with International patent practice. That is, the word does not preclude additional or unrecited elements, substances or method steps, in addition to those specifically recited. Thus, the described apparatus, substance or method may have other elements, substances or steps in various embodiments. The term “comprising” (and its grammatical variations) as used herein are used in the inclusive sense of “having” or “including” and not in the sense of “consisting only of”.

### BRIEF DESCRIPTION OF THE DRAWINGS

Notwithstanding any other forms which may fall within the scope of the present disclosure, a preferred embodiment will now be described, by way of example only, with reference to the accompanying drawings in which:

FIG. 1 shows a diagram of an example embodiment of a supply chain management system.

FIG. 2 shows a schematic diagram of an example configuration of the supply chain platform that forms part of the supply chain management system.

FIG. 3a shows a schematic diagram of an example configuration of a buyer device.

FIG. 3b shows a schematic diagram of an example configuration of a supplier device.

FIG. 4 shows an example method of managing a supply chain as implemented on the supply chain management system of FIG. 1.

FIG. 5 shows another example method of managing a supply chain as implemented on the supply chain management system of FIG. 1.

FIG. 6 shows an example order creation screenshot that allows a buyer to create an order.

FIG. 7 shows a supplier list screenshot, the screenshot illustrating the available suppliers that a buyer can select.

FIG. 8 shows an example quotation request screen, which illustrates quotations from various suppliers.

FIG. 9 shows a supplier assignment screen that allows a buyer to assign each supplier with a product.

FIG. 10 shows an example screenshot presented to a buyer device to allow the buyer to define a quality assurance plan.

FIG. 11 shows an example screenshot presented to a buyer to allow a buyer to define different inspection standards for various products based on a number of parameters.

FIG. 12 shows an exemplary screenshot that allows the buyer to select inspection bookings for the various products that have been ordered.

FIG. 13 illustrates an example screenshot presented to the buyer device that illustrates the milestone information related to the specified milestones by the buyer.

FIG. 14 illustrates an example screenshot illustrating a quotation screen for the supplier.

FIG. 15 a supplier projects screen that presents the current projects a supplier is working on.

FIG. 16 an example screen shot of a supplier testing screen that illustrates the testing schedule used by the supplier.

### DETAILED DESCRIPTION OF A PREFERRED EMBODIMENT

Supply chains are vital to modern commerce and an effective supply chain management is always a need for businesses. Both suppliers and buyers have an interest in optimising a supply chain. An optimised supply chain can help in reducing the cost of products and improve the speed of delivering products.

The present disclosure relates to a supply chain management system and a method for managing a supply chain. A supply chain as described herein denotes a system of organisations, people, activities, information and resource involved in moving products (e.g. goods and/or services) from a supplier to a buyer. Expressed another way a supply chain is a network of entities directly or indirectly interlinked (e.g. suppliers, quality inspectors, manufacturers etc.) and interdependent in serving one or more buyers. A supply chain represents a network of all parties, resources, activities and technology involved in the creation and sale of a product (e.g. a good or a service).

The supply chain management system, as described herein allows two or more parties, e.g. buyers and suppliers to interact with each other to manage the flow of goods or services between the two or more parties. The supply chain management system, in one example, is an online management system that facilitates supply chain management for buyers and sellers via a wireless communication system e.g. the internet. The supply chain management system described herein, provides a real time system for improving supply chain functions. The supply chain management system as described herein further contributes to improving the efficiency of established supply chains.

The supply chain management system in a broad sense comprises a hardware platform that provides an online system that links buyers and sellers. The platform functions as a gateway between buyers and sellers and assists in completing several steps required in the supply chain. The platform is an internet based platform that is implemented on a hardware system. The platform improves efficiency of the supply chain.

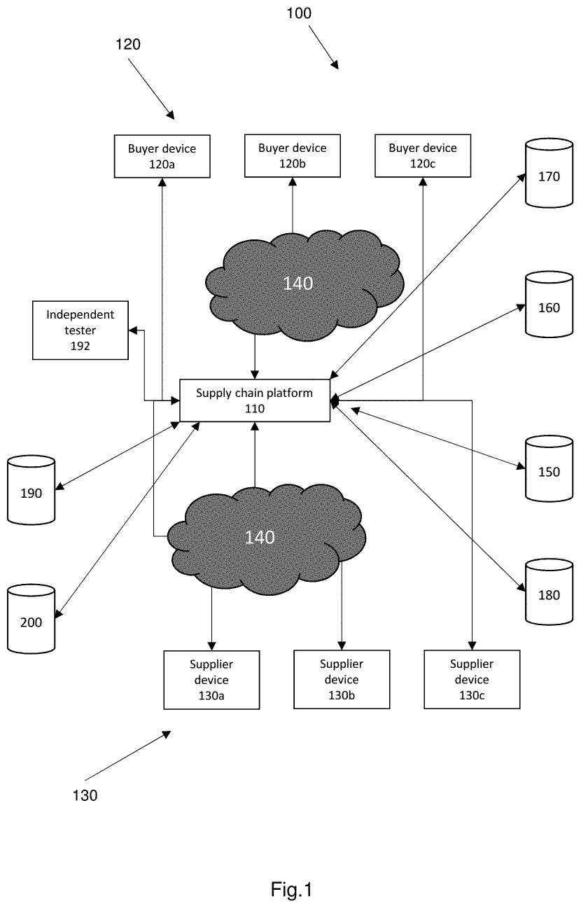

FIG. 1 shows an example form of a supply chain management system 100. FIG. 1 shows an example supply chain management system architecture. The example embodiment illustrates various components of the supply chain management system 100.

Referring to FIG. 1, the supply chain management system 100 comprises a supply chain platform 110. The supply chain platform 110 is arranged in electronic communication with one or more buyer devices 120 and one or more supplier devices 130. FIG. 1 shows an example system configuration that includes three buyer devices 120a, 120b, 120c (collectively referred to as 120). FIG. 1 also shows an example system configuration that includes three supplier devices 130a, 130b, 130c (collectively referred to as 130).

At least one buyer device 120 is associated with a buyer and at least one supplier device 130 is associated with a supplier. The supply chain platform 110 is electronically and wirelessly linked with each of the buyer devices 120 and the supplier devices 130. The supply chain platform 110 electronically communicates with the buyer devices 120 and the supplier devices via a suitable wireless communication network 140 such as for example a 3G network, 4G network, Wifi, WAN or any other suitable wireless communication network or telecommunication network. The supply chain platform 110 comprises a hardware computing device that is enabled for wireless communication. Each of the buyer devices 120 and supplier devices 130 are also computing devices that are enabled for wireless communication.

The supply chain management system 100 further comprises a transaction record database 150 that is arranged in electronic communication with the supply chain platform 110. The transaction record database 150 is adapted to store transaction records associated with transactions that are facilitated between buyers 120 and suppliers 130. The transaction record database 150 may be stored on or within the supply chain platform 110. Alternatively the transaction record database 150 may be implemented or stored on a separate hardware device e.g. a memory unit or a computing device or as part of a cloud storage or cloud based database system.

The system 100 also comprises a shipping information database 160. The shipping information database 160 is adapted to store shipping information. The shipping information comprises a shipping date, a shipping itinerary and shipping provider The shipping information database 160 may be implemented within or as part of the supply chain platform 110. Alternatively the shipping information database 160 may be stored on or within the a separate computing device or a cloud based database system.

The system 100 comprises a supplier database 170 that is arranged in electronic communication with the supply chain platform 110. The supplier database 170 is arranged to stored supplier information within it. The supplier database 170 may be stored as part of the supply chain platform 110. Alternatively the supplier database 170 may be implemented on a separate hardware device e.g. a computing device or within a cloud computing system.

The system 100 further comprises a product certification database 180 adapted to store compliance to quality standards. The product certification database 180 may stored within the supply chain platform 110. Alternatively the product certification database 180 may be stored in a cloud computing system or a separate computing device. The supply chain platform 110 is configured to store compliance to the quality standards associated with each product supplied by the supplier within the product certification database

Referring to FIG. 1, the supply chain management platform 100 may also comprise one or more independent tester devices 192. Each independent tester device 192 is associated with an independent tester. The independent tester may be any suitable entity that can be used to conduct independent quality assurance testing and testing to ensure products adhere to particular specified standards.

The system includes an independent tester database 190, as shown in FIG. 1. The independent tester database 190 may be stored within the supply chain platform 110. Alternatively the independent tester database 190 may be stored in separate computing device or on a cloud computing device. The independent tester database stores details of the independent testers that can be engaged by a buyer or supplier or any other party within the supply chain. The independent tester database 190 further is configured to store details of the tests the independent testers are qualified to perform. The independent tester database may also stored a plurality of quality assurance standards. The supply chain platform 110 is configured to refer to the independent tester database and identify an independent tester in response to receiving a request for independent testing from a buyer.

The system 100 further may optionally include a shipping database 200 configured to store shipping details of a product. The shipping details may include the day and time of shipping and the location of the product during the shipping process. The shipping database 200 may be updated regularly to track the position of the product. The supply chain platform 110 is further configured to update the buyer device with a location of the product while the product is being shipped. The supply chain platform 110 is configured to stop updating the position of the product once the platform 110 receives a receipt confirmation from the buyer device.

The databases described herein are arranged in electronic communication with the supply chain platform 110. The supply chain platform 110 may be configured for bi-directional (i.e. two way) communication with the databases. The supply chain platform 110 can read data from and write data to the databases described herein. Alternatively the supply chain platform 110 may be configured for unidirectional (i.e. single direction) communication. For example in this alternative configuration the supply chain platform 110 may be configured to read data from some databases and write data to some databases.

The databases described above reside on disk or other storage device as described earlier. The disk or storage device may be part of the platform 110 or may be part of a separate computing device or computing system. Any one or more of the databases described earlier may be implemented as relational databases and the databases are configured to store various types of data. Further details of the type of data stored on each of the databases will be provided later.

The supply chain platform 110 comprises a server and is configured to wirelessly communicate with the buyer devices 120 and supplier devices 130 via a suitable wireless communication network, and wherein the supply chain platform is arranged in a server client relationship with the buyer devices and the supplier devices, such that the supply chain platform functions as the server.

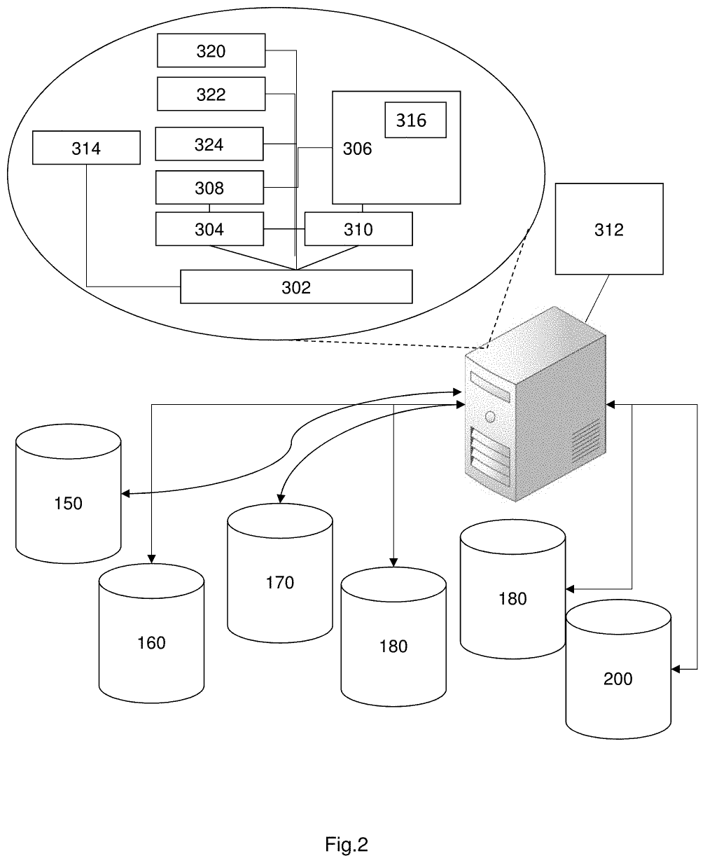

FIG. 2 shows an example configuration of the supply chain platform 110. Referring the FIG. 2 the platform 110 comprises a computing device e.g. a server. The server comprises at least a hardware processor unit and a memory unit. The processor unit and memory unit being in electronic communication with each other. In one example embodiment the server 110 is implemented by a computer having an appropriate interface. The computer may be implemented by a suitable computing architecture. In one example the platform 110 is implemented in a stand alone PC. Preferably the platform 110 may be implemented as part of a cloud computing architecture. In a cloud computing architecture the platform may be implemented across a plurality of shared computing resources e.g. a plurality of servers. The cloud computing architecture may be provided by a separate cloud computing provider. The platform 110 may be implemented in any suitable service model.

In a further alternative configuration, the platform 110 may be implemented as a further client/server architecture or computing device, or a terminal/mainframe architecture or any other appropriate architecture.

FIG. 2 shows an example configuration of the platform 110 implemented as a server as a stand alone PC. Referring to FIG. 2 there is a shown a schematic diagram of the supply chain platform 110 which in this embodiment comprises a server 110. The server 110 comprises suitable components necessary to receive, store and execute appropriate computer instructions. The components may include a processor unit 302, read-only memory (ROM) 304, random access memory (RAM) 306, and input/output devices such as disk drives 308, input devices 310 such as an Ethernet port, a USB port, etc. Optionally the platform 110 may comprise a display 312 such as a liquid crystal display, a light emitting display or any other suitable display and communications unit 314. The communication unit 314 is electrically coupled to the processor unit 302, and is configured to facilitate connection to a communication network and allow the platform 110 to communicate with the user device, supplier devices, independent tester devices and other devices. The communication unit 314 can connect to an external communication network or an external computing network through a telephone line or another type of communication link.

In an alternative configuration there may be provided a plurality of communication units 314 which may variously connect to one or more computing devices such as a server, personal computers, terminals, wireless or handheld computing devices. At least one of a plurality of communications units may be connected to an external computing network through a telephone line or other type of communications link.

The server 110 includes instructions that may be included in ROM 304, RAM 306 or disk drives 308 and may be executed by the processor unit 302. The platform 110 (i.e. server 110) may include storage devices such as a disk drive 308 which may encompass solid state drives, hard disk drives, optical drives or magnetic tape drives. The server 110 may use a single disk drive or multiple disk drives. The server 110 may also have a suitable operating system 316 which resides on the disk drive or in the ROM of the server 110 (i.e. platform).

The platform 110 comprises a quality assurance engine 320, a shipment engine 322 and an analytics engine 324. Each of the engines 320, 322 and 324 may be implemented as hardware modules such as for example integrated circuits or chips or microprocessors or digital circuits or hardware modules or any other suitable electronic component arrangement. The quality assurance engine 320, the shipment engine 322 and the analytics engine 324 are arranged in electronic communication with the processing unit 302 and one of the storage elements e.g. a disk drive 308. Each of the engines may be in the form of hardware and software modules.

Alternatively each of the engines 320, 322, 324 may be implemented as software modules. The software modules may comprise computer readable and executable instructions that are stored within a storage device of the platform e.g. a memory unit or one of the disk drives. The instructions may be executed by the processor unit 302.

The supply chain platform 110 may also comprise additional hardware components e.g. microprocessors or integrated circuits or digital circuits to provide the functionality described herein. The supply chain platform 110 may also include additional software modules or software programs in order to provide the functionality described herein.

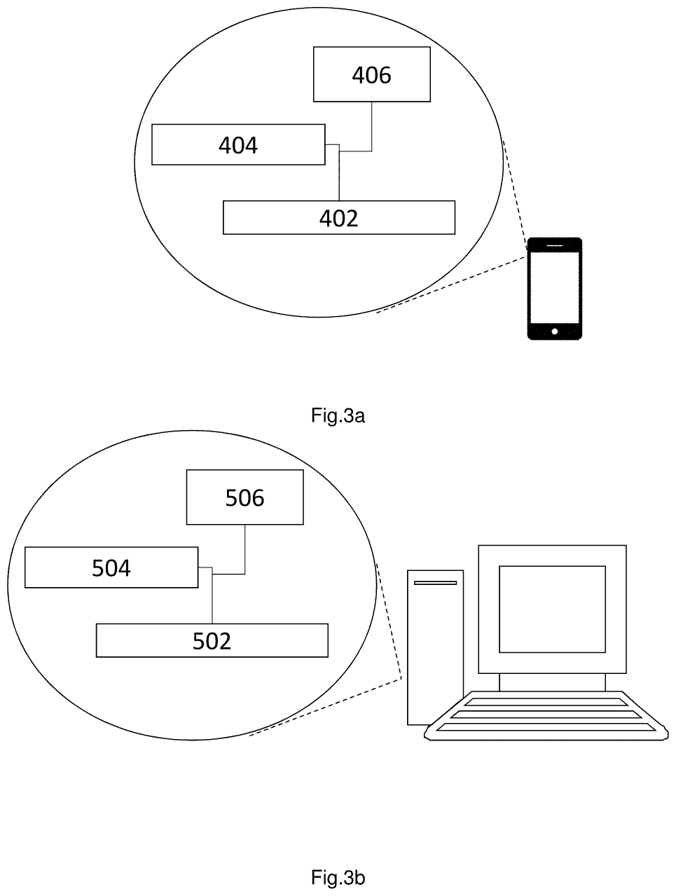

FIG. 3a shows an example form of the buyer device 120. The buyer device 120 is preferably a computing device that includes at least a processor 402 and a memory unit 404. The memory unit 404 may be a disk drive or a solid state memory unit or any other suitable memory unit. The buyer device 120 comprises one or more software programs or software modules that include instructions, which define functionality of the buyer device. The buyer device 120 also may include a communication module 406 to enable the buyer device to connect to a communication network and wirelessly communicate with the platform 110. The buyer device 120 may be a stand alone PC or a laptop or a mobile device such as for example a tablet or a smartphone. The buyer device 120 may include any additional hardware components or software programs that can provide the functionality described herein. In the illustrated example the buyer device 120 is a tablet.

FIG. 3b shows an example form of the supplier device 130. The supplier device 130 is a computing device including at least one processor 502 and at least one memory unit 504. The memory unit 504 may be a disk drive or a solid state memory unit or any other suitable format. The supplier device 130 further comprises a communication module 506 configured to allow the buyer device to wirelessly communicate with the platform and any other devices within the system 100. The supplier device 130 may be a stand alone PC or a tablet or a smartphone or any other suitable device. In the illustrated example the supplier device is a PC

Each of the buyer and supplier devices may also include a software application. The software application is a supply chain software application (i.e. a supply chain app). The software application be programmed stored on a disk drive or ROM. In another form the software application may be stored as firmware. The application can be executed by a processor or another one or more hardware units. The supply chain app allows the buyer device and/or the supplier device to access the supply chain platform 110 and interact with the supply chain platform 110. The supply chain platform 110 functions as a server and the buyer and supplier devices function as clients, within the server client architecture. The app includes instructions to access the platform 110 and facilitates electronic linking and communication between the platform 110 and the buyer and supplier devices.

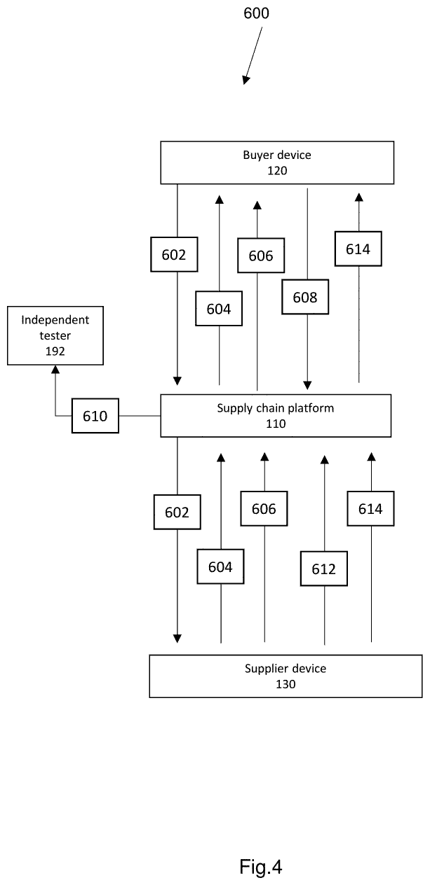

FIG. 4 shows an example method of managing a supply chain 600 utilising the supply chain management system 100. The method will be described as a series of steps. The method of managing a supply chain 600 is performed by the supply chain platform 110. Generally prior to using the supply chain management system 100, the buyer and supplier may preferably have established a business relationship. The buyers and suppliers can use the system 100 to improve management of the various events in the transfer of products between the suppliers and buyers.

Referring to FIG. 4, the method 600 commences at step 602, wherein step 602 comprises receiving a purchase order by the platform 110 from the buyer device 120 and providing the purchase order to the supplier device 130. The purchase order includes order information defining at least one or more products required and one or more quality standards the products should adhere to. Step 604 comprises receiving a confirmation of the order from the supplier device 130 and providing the confirmation to the buyer device 120. The conformation of the order may also include the quality certifications related to the supplier. The buyer device is presented with a confirmation of the order including the quality certifications related to the supplier.

Step 606 comprises receiving an order update from a supplier device 130 and providing the order update to the buyer device 120. The order update includes status information from the supplier device regarding the product. The status information may also include if one or more predefined milestones defined by the user are achieved. The status information may be received from the supplier device and provided to the buyer device at regular time intervals such that the buyer can remain abreast of the status of the product or products being produced, e.g. the quantity produced, the quality standards being adhered to etc.

Step 608 comprises receiving a quality assurance (QA) request. The QA request includes quality and/or regulator standards that are defined by the buyer. Step 610 comprises providing an independent tester a request to test the product and/or the supplier manufacturing process or equipment of site to check for compliance to the defined by the buyer (or legislation). The platform 110 is configured to facilitate testing of the product and/or supplier premises and/or supplier manufacturing equipment for compliance to the defined standards. In one example form the method may comprise providing a user device with independent tester details from the independent tester database.

Step 612 comprises receiving quality testing results from the supplier device and providing the same to the buyer device. Step 612 may include compliance details or at least an indication if the supplier has achieved compliance to the defined quality standards. Step 612 may also additionally comprise receiving and providing quality certificates for the product to the buyer device. The compliance details are stored within the compliance database.

Step 614 comprises receiving shipping information from the supplier device and providing the shipping information to the buyer device. The shipping information includes at least a confirmation of shipping. The shipping information may also include the shipping company information. Shipping information may also include continuously providing the buyer device details of the location of the product during shipping. The supplier device may be configured to provide location of the product at regular time intervals and this information may be provided to the buyer device by supply platform. This provides a buyer updates regarding the location of the product. The shipping information is stored in the shipping database and the shipping database may be updated regularly.

The method 600 as described above can be applied by the platform to interact with multiple suppliers and buyers. The method can be applied between one buyer and multiple suppliers or multiple buyers and a single supplier or between multiple buyers and multiple suppliers to facilitate supply chain management.

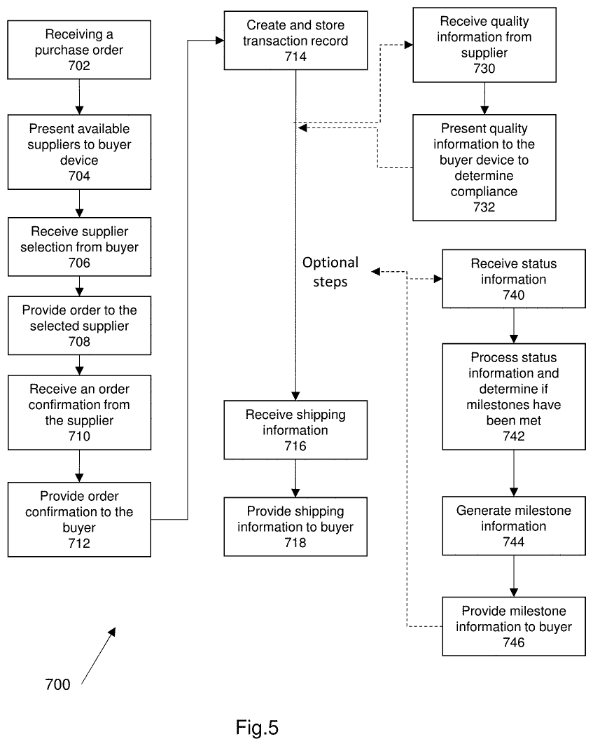

FIG. 5 shows a further example method of managing a supply chain 700 as implemented by the supply chain management system 100. The method of managing a supply chain 700 is implemented by the supply chain platform 110.

Referring to FIG. 5, the method 700 commences at step 702. The supply chain platform is configured to receive an order defining order information from the buyer device at step 702. The order information defines at least one or more products to be supplied, and one or more quality standards (i.e. quality and/or regulatory standards).

The supply chain platform 110 is configured to present one or more available suppliers to the buyer device at step 704. The available suppliers are presented such that the buyer can select one or more suppliers to work with. The supply chain platform is further configured to provide supplier information associated with supplier to the buyer device 120. The supplier information includes at least a supplier location and quality assurance certifications associated with the supplier.

The supply chain platform 110 is configured to receive a supplier selection from the buyer device at step 706. At step 708 the supply chain platform is configured to provide the order, including the order information, to the supplier device associated with the selected supplier. At step 710 the supply chain platform is configured to receive an order confirmation from the supplier device, the order confirmation denoting the supplier can fill the order. At step 712 the supply chain platform is configured to provide the order confirmation to the buyer device.

At step 714 the supply chain platform is configured to create and store a transaction record within the transaction record database 150. The transaction record is created and stored following receipt of the order confirmation from the supplier device 130. The transaction record comprises at least buyer information, seller information and the order information. The supply chain platform 110 is configured to receive shipping information from the supplier device at step 716. At step 718 the supply chain platform 110 is configured to provide the shipping information to the buyer device 120. The shipping information comprises at least a shipping date, a shipping itinerary and shipping provider.

In an example embodiment the order information comprises a plurality of parameter, the parameters including one or more of:
a desired delivery date;
cost of production;
cost of shipping;
one or more standards the product is required to adhere to;
quantity of product required, and;
one or more predefined milestones.

In an example embodiment the supplier information comprises a plurality of parameters including one or more of:
quality assurance certifications;
location;
types of products supplied by the supplier;
production equipment details
types of manufacturing processes that can be performed by the supplier.

As stated above the buyer may specify one or more standards if the buyer is aware of the required standards. In the case the buyer is not aware of the required standards, the buyer may provide a request for standards information to the platform 110. The platform 110 is configured to determine the required standards and populate the order information with the required standards. The platform 110 may also be configured to automatically provide recommendations of the required standards to one or more buyers and then populate the order with the required standards prior to providing the order to a supplier. In one example the system 100 may include a standards database (not illustrated) or alternatively a record of standards. The standards database or record of standards may be stored within the platform e.g. on one of the disk drives or in ROM. The standards database may also include various standards that may be arranged by regulatory authority and/or the product. The platform may also be configured to pull information regarding any changes to standards from regulatory authorities like TUV or FDA etc. The platform 110 may in one example pull information from the regulatory authority websites, and updated the standards database with changes. The platform 110 may be configured to automatically interrogate regulatory authority websites or records at predetermined time intervals. Alternatively the standards may be uploaded by a user or an administrator of the platform. Preferably the standards database is continuously expanded to reflect changes to standards as defined by various regulatory authorities.

The supply chain platform 110 is further configured to identify one or more available suppliers from the supplier database prior to step 704, based on comparing the order information the supplier information associated with each supplier. In one example the supply chain platform 110 is configured to identify the one or more available suppliers by comparing parameters of the supplier information associated with each supplier with one or more parameters of the order information, and the one or more suppliers being identified if two or more supplier information parameters correspond to two or more parameters of the order information.

In one example at step 704 the platform 110 is configured to present the one or more available suppliers in an order based on the amount of matches between one or more parameters of the supplier information and one or more parameters of the order information.

At step 730 the supply chain platform 110 is configured to receive quality information associated with a specific product being supplied by the supplier and wherein the quality information comprises at least the compliance to the quality standards defined in the order information. Step 730 is an optional step that may be executed by the platform 110.

The product certification database 180 is adapted to store compliance to quality standards. The supply chain platform 110 is configured to store compliance to the quality standards associated with each product supplied by the supplier within the product certification database 180. The product certification database may also include compliance templates such as for example BoM (bill of materials) templates, GCC/CPC/DoC (declaration of conformity) templates. The templates can be accessed by suppliers or independent testers through the platform 110. The platform 110 may be configured to download new templates and store them in the product certification database.

The method 700 may comprise the additional optional step 732. At 732 the supply chain platform 110 is configured to present the quality information to the buyer device 120 such that the buyer can determine if the supplier has adhered to defined quality standards. The platform 110 may receive regular updates regarding the buyer quality standards are being adhered to. Steps 730 and 732 are preferably conducted prior to step 716 and may be repeated during the process of producing products.

The supply chain platform 110 is configured to receive milestone information from the supplier device and provide the milestones to the buyer. This allows the buyer to remain aware of the progress of the product. The method 700 may include the following additional steps. At step 740 the supply chain platform is configured to receive a status information from the supplier device 130 at regular time intervals, wherein the status information is related to a product defined within the order details. The status information may include one or more of: a production status (i.e. how many products have been produced), the manufacturing or supply cost that has been incurred, the quality assurance testing conducted, the product yield i.e. pass and fail rate during manufacturing.

The one or more predefined milestones can be any suitable milestones. For example the one or more predefined milestones may be factory audits, standards compliance testing, product testing, product inspection, the dates of production batches, technical files being completed or any other milestones defined by a buyer.

At step 742 the supply chain platform 110 is configured to process the status information and determine if any one or more predefined milestones have been achieved. The one or more milestones are preferably predefined by the buyer. The milestones may be defined as part of the order information. At step 744 the supply chain platform 110 is configured to generate milestone information that comprises data related to any of the one or more predefined milestones has being achieved by the supplier. At step 746 the supply chain platform 110 is configured to provide the milestone information to the buyer device 120. This is advantageous because it allows a buyer to monitor progress by the supplier. The milestone information may include specific information related to an order for a product such as for example if a first batch has been produced, a target yield etc. The method steps 742 to 746 are optional steps. The steps 742 to 746 are preferably executed prior to steps 716 and 718 if the supply chain platform 110 is configured to perform steps 742 to 746.

As described earlier the system 100 may comprise an independent tester database 190. The independent tester database 190 is configured to store details of one or more independent testers and details of the tests the independent testers are qualified to perform.

The supply chain platform 110 allows a buyer to engage an independent tester to test products produced by the supplier at a desired time e.g. prior to shipping. The independent quality tester may be used to ensure compliance of the products produced as well ensure compliance of the supplier processes and/or the supplier equipment.

In one form the supply chain platform 110 can also allow buyers to select an independent tester that may provide the cheapest testing service. The platform 110 may receive a request to access an independent tester. The independent tester details can be accessed by the platform 110 from the independent tester database 190. The details of the independent tester selected by the buyer can be contacted by the buyer. The platform 110 can receive a request to conduct a plurality of standards tests defined by a buyer. The request is transmitted to a selected independent tester. The independent tester device can receive the request and provide a confirmation to the platform, the confirmation being transmitted to the buyer. The independent tester can conduct the tests and transmit the testing results to the platform. The platform 110 is configured to transmit the testing details to the buyer and also store if the buyer specified standards are met by the supplier. The above optional steps can be incorporated as part of method 700.

In another example form the platform 110 is configured to provide a request for an independent tester from the buyer to each independent tester within the independent tester database 190. The platform 110 is configured to receive quotations and/or other information for testing from each independent tester. The other information may include the time to conduct the testing or types of testing that can be performed or any other parameters. The platform 110 provides a tender system where each independent tester can provide a quote regarding the requested testing by the buyer. The platform 110 transmits the received quotations to the buyer device. The platform 110 may also be configured to process the received quotation information and present a list of independent testers in an ascending order of quotation values. Alternatively the independent testers may be presented in a descending order of quotation values. The buyer can select a desired independent tester based on the quotations and/or other information provided by the independent testers. The buyer may select the independent tester that provides the cheapest quote thereby providing a system that can facilitate a cost effective manner of conducting independent testing of suppliers and achieve compliance in a cost effective manner. The tender system may also be part of method 700 as described. The system 100 provides a simple and efficient way for a buyer to select an independent tester in order to ensure compliance of suppliers.

The supply chain management 110 comprises a quality assurance engine 320 arranged in electronic communication with the processor unit and/or the memory unit e.g. the disk drive. The quality assurance engine 320 may be a hardware module or software program e.g. a software plug in or a API or a firmware program.

The quality assurance engine 320 (or the supply chain platform 110) being configured to receive details of an independent tester and a test request, wherein the test request defining one or more standards that a product from a supplier should adhere to. The quality assurance engine 320 (of the supply chain platform 110) configured to provide the test request to an independent tester device associated with the independent tester. The quality assurance engine 320 (the supply chain platform 110) further being configured to provide the supplier device with details of the independent tester. The quality assurance engine 320 (or supply chain platform 110) is also configured to process the test request, and provide a list of independent testers to the buyer device wherein the list of independent testers is compiled from the database of independent testers.

The quality assurance engine 320 may be configured to select independent testers for the list based on the type of testing regime the independent tester can conduct. The quality assurance engine 320 (or the supply chain platform 110) is configured to identify independent testers, for the list, based on if the independent tester can conduct the one or more tests required to show compliance to the one or more standards defined in the order information.

The quality assurance engine 320 (or the supply chain platform 110) is configured to receive test result from the supplier device 130 following testing executed by the independent tester and provide the test results to the buyer device. The test results may be received from the independent tester device at the platform 110. Alternatively the platform 110 may receive raw test results from the independent tester device, process the test results and determine if the test results illustrate compliance, by the supplier, to one or more standards that are defined by the buyer.

The supply chain platform is also configured to create a compliance profile for each supplier, wherein the compliance profile comprises one or more compliance certificates. The platform 110 is configured to create a compliance profile for each supplier. The compliance profile associated with each supplier can assist other buyers in selecting a suitable supplier. The supplier can be selected by a buyer based on the compliance profile of the supplier, since the compliance profile includes one or more compliance certificates. The compliance profile can assist a buyer in determining a supplier that can provide a product that meets specific quality and/or regulatory standards.

The supply chain platform 110 comprises a shipment engine as described earlier. The shipment engine 322 configured to process shipping information and store shipping information in the shipping database. The shipment engine further configured to communicate with a shipping company and track the location of a product being shipped, and the shipment engine configured to provide the location of the product to the user device at predetermined time intervals. The regular updating of location allows the buyer to track the location of the product through to delivery. The platform 110 is advantageous because it facilitates shipping and provides updates to the buyer regarding the location of the product.

The supply chain platform 110 also includes an analytics engine 324. The analytics engine is configured to process a variety of data in response to a user request. Alternatively the analytics engine may be configured to process data at regular intervals. The analytics engine 324 can be used to process various data to determine supply chain performance such as for example a product pass/fail rate and quality standards compliance costs. The data can be processed and presented by product type or supplier or country or another suitable parameter. The analytics engine 324 can be used to build a supplier performance analysis and provide this to a user. For example the analytics engine (or the platform 110) can be configured to provide a score card system and rate suppliers based on the score card system. The analytics engine 324 allows a buyer to analyse testing, inspection and factory audit data, such as for example pass/fail rates, expenses, failure reasons etc. The analytics engine 324 allows a buyer to process various information in order to assess the effectiveness of a supplier or effectiveness of a supply chain or other data analytics.

The system 100 can also include additional functionalities in addition to those described earlier. For example the platform 110, of system 100, is configured to generate and transmit reminders to one or more suppliers if a purchase order i.e. an order is not responded to by a supplier. If an order has been provided to one or more suppliers, the platform 110 may include a timer to monitor for receipt of an order confirmation from a supplier device. If the order confirmation is not received within a predefined time period, the platform 110 is configured to auto generate reminders to the supplier. The platform 110 is also configured to send reminders to a supplier device if shipping information has not been received in a predetermined time period. The platform 110 is configured to monitor time limits and assists in maintaining checks to ensure that products e.g. goods and/or services are delivered to a user in a timely manner by the supplier.

The platform 110 is configured to monitor the validity of test reports and/or compliance certificates. For example the platform 110 can monitor if the test reports and/or compliance certificates associated with various products or various suppliers are still current or have expired. The platform 110 can generate reminders if test reports and/or compliance certificates are expired. The platform 110 functions as a gateway that allows various parties to share documents. For example buyer devices and supplier devices can shared documents and/or messages. Similarly buyers and suppliers can transmit and receive messages from independent testers.

In one form the platform 110 allows a buyer to approve or reject testing certificates provided by the supplier online. The platform 110 may also allow a buyer to approve or reject testing certificates in real time. The platform 110 can also allow a buyer and/or a supplier to receive and verify an independent tester reports.

Example screenshots of the system in use are shown. The supply chain management system 100 defines a online system that interconnects various buyers, sellers and independent testers. The platform 110 is an online web based system. The buyer and supplier is required to perform an initial registration procedure and create a user profile. Each buyer, supplier and independent tester is required to sign up and input some basic information. The information e.g. supplier information can be used to create a user profile for each user e.g. a buyer, supplier and independent tester.

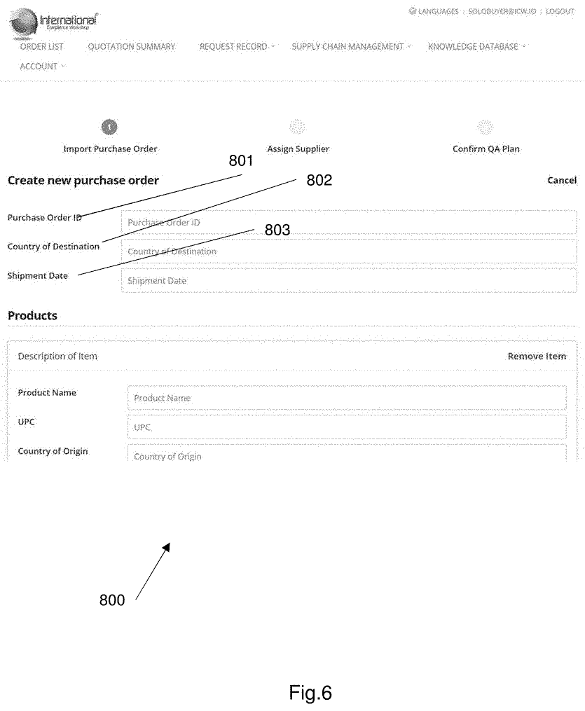

FIG. 6 shows an example order creation screenshot 800. The order creation screenshot 800 is presented to the buyer such that the buyer 120 can place an order. The order creation screenshot 800 provides a location to include a purchase order ID 801, a destination for product delivery 802 and a shipment date 803. The buyer is also define one or more products in a product ordering region on the screenshot 800 titled “PRODUCTS”.

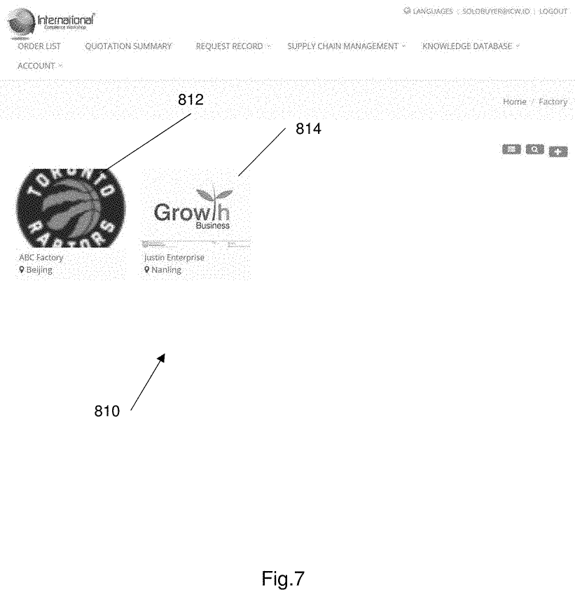

FIG. 7 shows a supplier list screen shot 810. The screenshot 810 shows a list of suppliers e.g. factories that can be used by the buyer. The list of suppliers may be identified based on the capabilities of the supplier e.g. based on comparing the parameters of the supplier information with the associated parameters in the order request. As shown in FIG. 7, the screenshot illustrates two suppliers 812, 814 that can be used. The buyer can select one or more suppliers to work with.

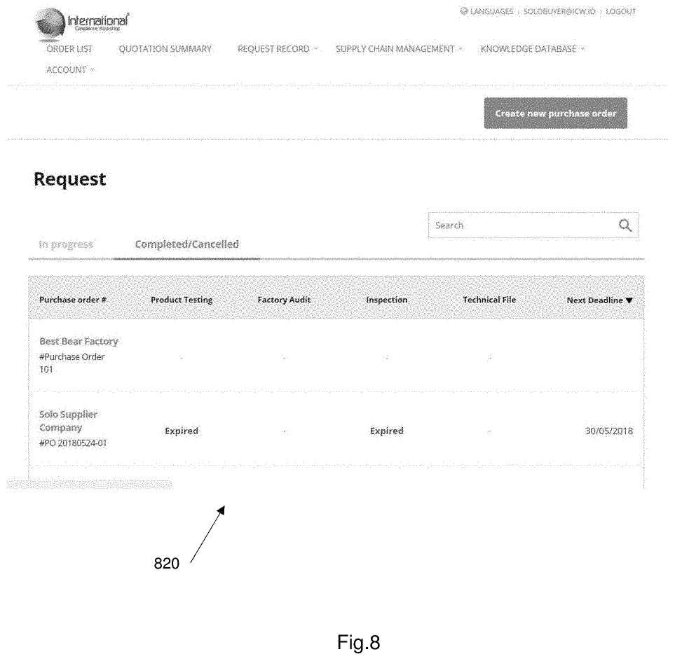

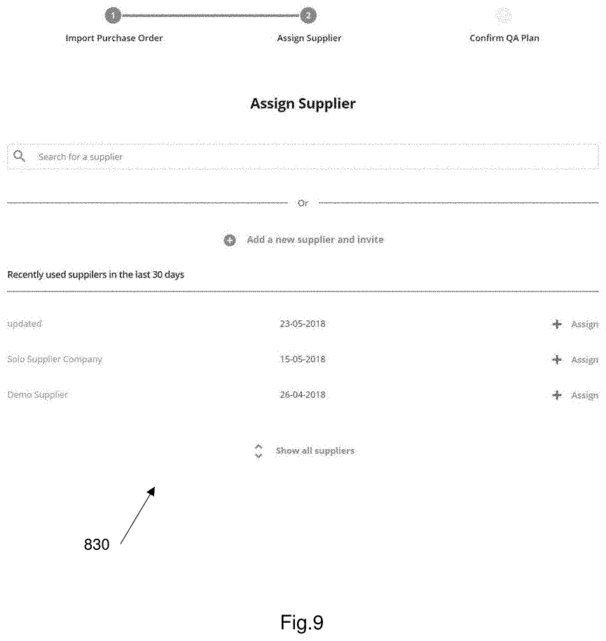

FIG. 8 shows an example quotation request screen 820. The quotation request screen 820 includes quotations that are presented from each supplier. The buyer can view each quotation and select a preferred quotation. FIG. 9 shows a supplier assignment screen 830. The supplier assignment screen 830 is presented to the buyer on the buyer device 120. Screen 830 allows a buyer to assign a specific supplier to supply a product.

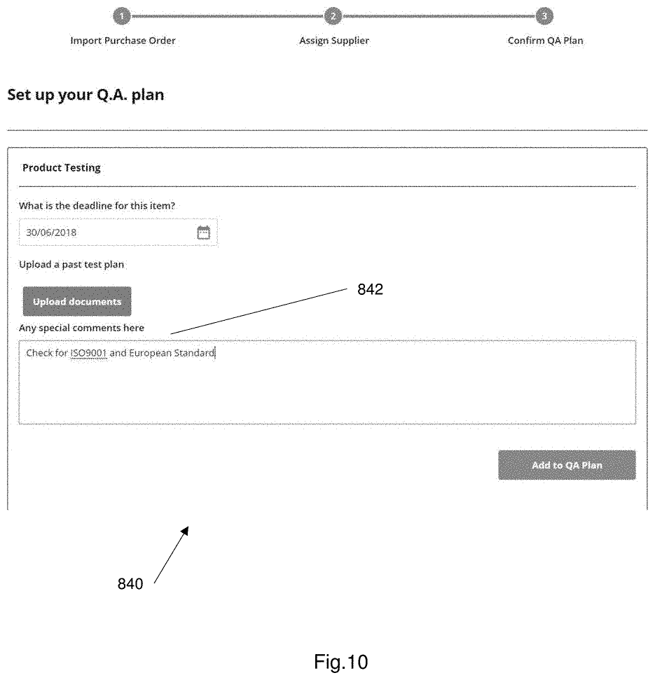

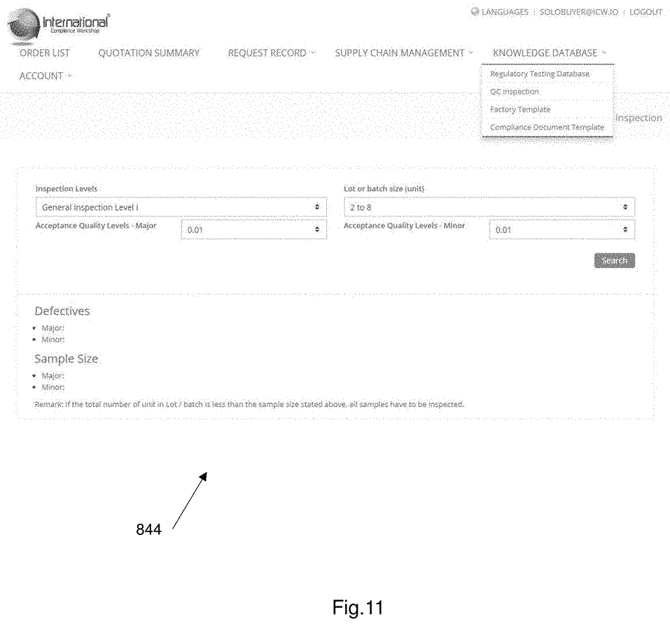

The buyer can define a quality assurance plan for each supplier that is selected. FIG. 10 shows an example screenshot 840 presented to a buyer device to allow the buyer to define a quality assurance plan. The quality assurance plan can specify any particular quality standards that products should adhere to. For example in FIG. 10, a quality standard 842. In FIG. 10, an ISO9001 and European Standard are defined. The supply chain platform 110 is also configured to allow a buyer some customisation regarding the required quality standards. For example as shown in screenshot 844 in FIG. 11, the buyer can define different inspection standards for various products based on a number of parameters such as for example based on the product's final destination.

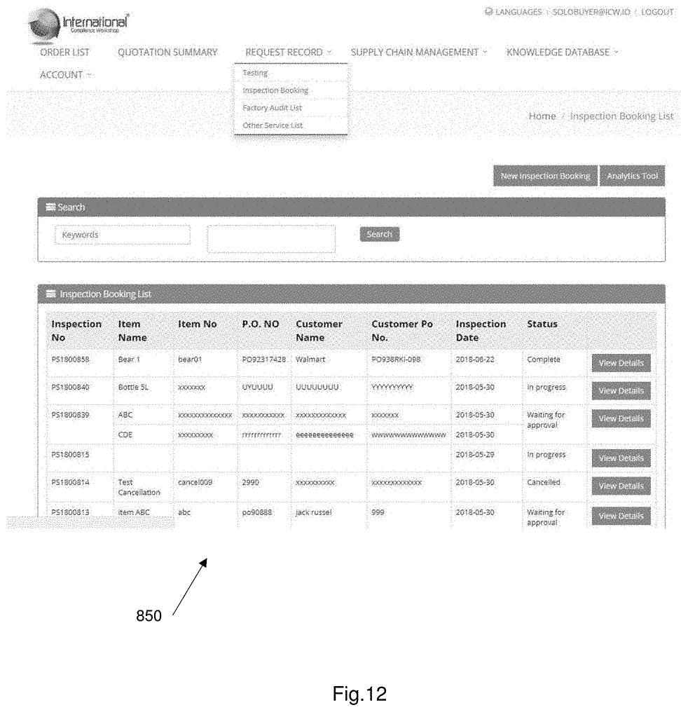

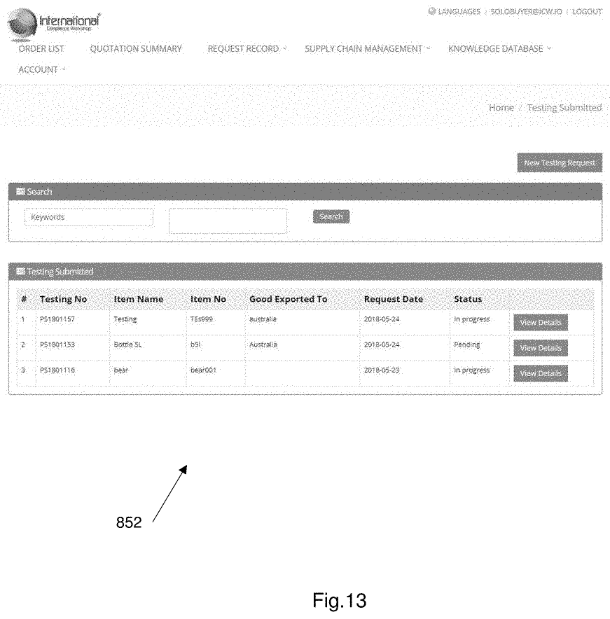

FIG. 12 shows an exemplary screenshot 850 that allows the buyer to select inspection bookings for the various products that have been ordered. The inspection bookings can relate to the time an independent tester would test the products. FIG. 13 illustrates an example screenshot presented to the buyer device that illustrates the milestone information related to the specified milestones by the buyer. FIG. 13 shows a screen shot 852 that present various products, testing information (e.g. testing number) and the status. The screenshots shown in FIGS. 6 to 13 are screenshots presented to the buyer on the buyer device. The screenshots may be web pages or web interfaces.

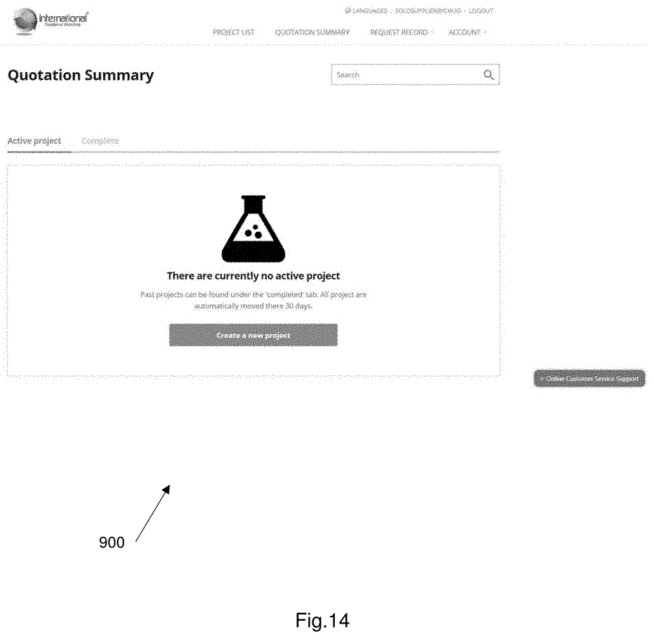

FIG. 14 illustrates an example screenshot that is a supplier interface. FIG. 14 shows a quotation interface for a supplier. FIG. 14 shows there is no current active project for the particular supplier. The screen 900 allows the supplier to upload quotation information and create a quotation. The quotation information is received by the supplier platform 110 and presented to the buyer e.g. in the format of screen 820.

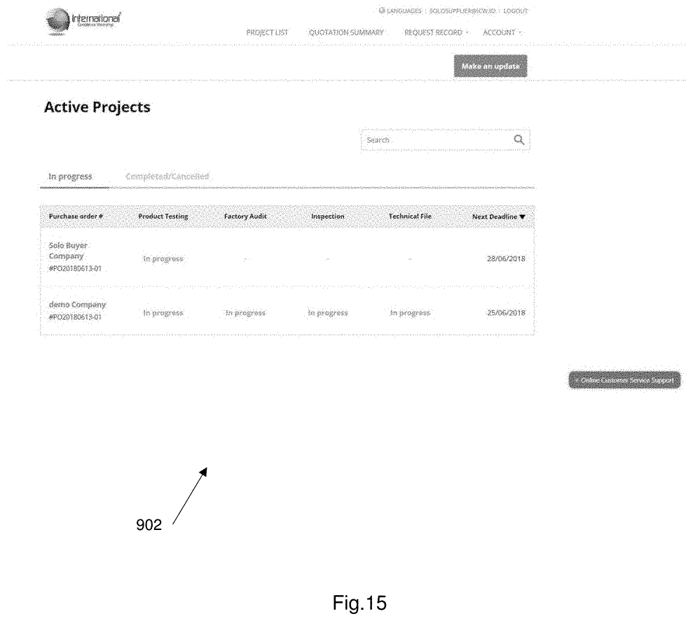

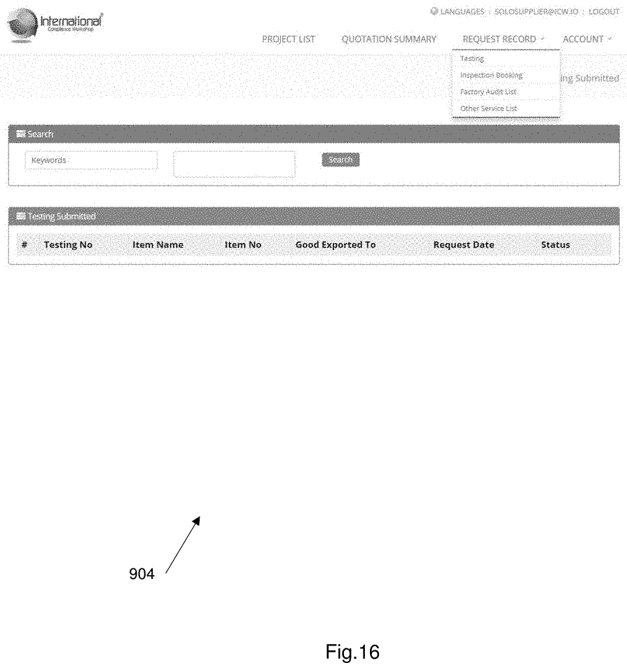

FIG. 15 shows a supplier projects screen 902. The screen 902 shows a list of the active projects associated with a particular supplier. The screen 902 can also allow a supplier to upload additional projects e.g. by updating the list. The list of projects can be presented to the buyer and/or can be used to determine if a supplier has capacity to take on additional projects. FIG. 16 shows an example screen shot of a supplier testing schedule 904. The supplier testing schedule is associated with a supplier and allows a supplier to add a testing protocol. The screenshot 904 also illustrates the various parameters associated with the testing.

Referring to FIGS. 6 to 16 there is a menu ribbon 910 that is presented in an upper portion of the screen. The menu ribbon includes a plurality of options that can be selected. The buyers and suppliers can have different options. The options are preferably arranged in a drop down menu. The various options and functions as described earlier are accessible via drop down menus. Other formats for the menu are also contemplated.

The supply chain management system and method as described herein is advantageous because it improves supply chain management. The supply chain management system facilitates a number of functions that enhance the cooperation between the buyer and supplier, including timely exchange of product specifications, certification information and quality assurance details. The supply chain management system is advantageous as it allows users to build compliance profiles for a plurality of suppliers and/or products based on quality standard compliance data. The system can also help in quality or regulatory audits since the system stores compliance and testing information. The supply chain management system is also advantageous because it allows a buyer to specific quality and/or regulator standards that are required to be met for various products. The system provides clarity regarding the required standards to buyers and sellers. The system also provides a scheme to store compliance information.

The supply chain management system is also advantageous because it links buyers and suppliers to independent testers. The supply chain management system allows a buyer to easily and quickly recruit an independent tester to test particular products from selected suppliers. The system is further advantageous because it allows suppliers to communicate with the independent testers and conduct testing or allow the testers to visit the supplier site and conduct testing. Other advantages can also become apparent from reading the specification.

The description of any of these alternative embodiments is considered example. Any of the alternative embodiments and features in the alternative embodiments can be used in combination with each other or with the embodiments described with respect to the figures.

The foregoing describes only a preferred embodiment of the present invention and modifications, obvious to those skilled in the art, can be made thereto without departing from the scope of the present invention. While the invention has been described with reference to a number of preferred embodiments it should be appreciated that the invention can be embodied in many other forms.

1. A method of managing a supply chain between a buyer device associated with a buyer and a supplier device associated with a supplier, wherein the method is executed by a supply chain platform comprising one or more hardware components, the method comprising the steps of:
receiving an order defining one or more order information from a buyer device, wherein the order information define one or more products and one or more quality standards,
presenting one or more available suppliers and supplier information associated with each supplier, the supplier information including at a supplier location and quality assurance certifications associated with the supplier,
providing the order, including the order information, to a selected supplier device,
receiving an order confirmation from the supplier device,
providing the order confirmation to the buyer device,
creating and storing a transaction record within a transaction record database, following receipt of the order confirmation from the supplier device, the transaction record comprising buyer information, seller information and the order information,
receiving shipping information from the supplier device,
providing shipping information to the buyer device, wherein the shipping information comprises a shipping date, a shipping itinerary and shipping provider.

2. The method of managing a supply chain in accordance with claim 1, wherein the order information comprises a plurality of parameter, the parameters including one or more of:
a. a desired delivery date;
b. cost of production;
c. cost of shipping;
d. one or more standards the product is required to adhere to;
e. quantity of product required, and;
f. one or more predefined milestones.

3. The method of managing a supply chain in accordance with claim 1, wherein the supplier information comprises a plurality of parameters including one or more of:
a. quality assurance certifications;
b. location;
c. types of products supplied by the supplier;
d. production equipment details
e. types of manufacturing processes that can be performed by the supplier.

4. The method of managing a supply chain in accordance with claim 2, wherein the method comprises the additional step of:
identifying one or more available suppliers from a supplier database based on the order information.

5. The method of managing a supply chain in accordance with claim 4, wherein the step of identifying the one or more available suppliers are identified by comparing parameters of the supplier information associated with each supplier with one or more parameters of the order information, and the one or more suppliers being identified if two or more supplier information parameters correspond to two or more parameters of the order information.

6. The method of managing a supply chain in accordance with claim 5, wherein the method the step of presenting one or more available suppliers are presented in an order based on the amount of matches between one or more parameters of the supplier information and one or more parameters of the order information.

7. The method of managing a supply chain in accordance with claim 1, wherein the method comprises the additional step of receiving quality information associated with a specific product being supplied by the supplier and wherein the quality information comprises the compliance to the quality standards defined in the order information.

8. The method of managing a supply chain in accordance with claim 8, wherein the method comprises the additional step of storing compliance to the quality standards associated with each product within a product certification database.

9. The method of managing a supply chain in accordance with claim 7, wherein the method comprises the additional step of presenting the quality information to the buyer device such that the buyer can determine if the supplier has adhered to defined quality standards.

10. The method of managing a supply chain in accordance with claim 2, wherein the method comprises the additional steps of:
receiving a status information from the supplier device at regular time intervals, wherein the status information is related to a product defined within the order details
processing the status information to determine if any of the one or more predefined milestones has been achieved,
generating information that comprises data related to any of the one or more predefined milestones has being achieved by the supplier,
providing the milestone information to the buyer device.

11. The method of managing a supply chain in accordance with claim 1, wherein the method comprises the additional steps of:
receiving details of an independent tester and a test request, the test request defining one or more standards that a product from a supplier should adhere to,
providing the test request to an independent tester device associated with the independent tester,
providing the supplier device with details of the independent tester.

12. The method of managing a supply chain in accordance with claim 11, wherein the method comprises the additional steps of processing the test request, and providing a list of independent testers to the buyer device wherein the list of independent testers is compiled from a database of independent testers.

13. The method of managing a supply chain in accordance with claim 12, wherein the independent testers selected for the list are selected based on if the independent tests can test for one or more standards defined in the test request.

14. The method of managing a supply chain in accordance with claim 11, wherein the method comprises the additional steps of receiving test results from the supplier device following testing executed by the independent tester and providing the test results to the buyer device.

15. The method of managing a supply chain in accordance with claim 1, wherein the method comprises the additional step of creating a compliance profile for each supplier, wherein the compliance profile comprises one or more compliance certificates.

16. A supply chain management system comprising:
a supply chain platform including at least one hardware processor unit and a memory unit, the processor unit and the memory unit arranged in electrical communication with each other,
the supply chain platform configured to electronically communicate with one or more buyer devices and one or more supplier devices,
a transaction record database adapted to store transaction records, a shipping information database adapted to store shipping information,
a supplier database arranged to store supplier information associated with a supplier,
the supply chain platform further configured to:
receive an order defining order information from the buyer device, wherein the order information defines one or more products to be supplied, and one or more quality standards,
present one or more available suppliers and the supplier information associated with each supplier on the buyer device, wherein the supplier information includes a supplier location and quality assurance certifications associated with the supplier,
receive a supplier selection from the buyer device,
provide the order, including the order information, to a selected supplier device,
receive an order confirmation from the supplier device, the order confirmation denoting the supplier can fill the order,
provide the order confirmation to the buyer device,
create and store a transaction record within the transaction record database, following receipt of the order confirmation from the supplier device, the transaction record comprising buyer information, seller information and the order information,
receive shipping information from the supplier device, and;
provide shipping information to the buyer device, wherein the shipping information comprises a shipping date, a shipping itinerary and shipping provider.

17. The supply chain management system in accordance with claim 16, wherein the order information comprises a plurality of parameter, the parameters including one or more of:
a desired delivery date;
cost of production;
cost of shipping;
one or more standards the product is required to adhere to;
quantity of product required, and;
one or more predefined milestones.

18. The supply chain management system in accordance with claim 16, wherein the supplier information comprises a plurality of parameters including one or more of:
quality assurance certifications;
location;
types of products supplied by the supplier;
production equipment details
types of manufacturing processes that can be performed by the supplier.

19. The supply chain management system in accordance with claim 16, wherein the supply chain platform is further configured to identify one or more available suppliers from the supplier database based on comparing the order information the supplier information associated with each supplier.

20. The supply chain management system in accordance with claim 19, wherein the supply chain platform is configured to identify the one or more available suppliers by comparing parameters of the supplier information associated with each supplier with one or more parameters of the order information, and the one or more suppliers being identified if two or more supplier information parameters correspond to two or more parameters of the order information.

21. The supply chain management system in accordance with claim 20, wherein the supply chain platform is configured to present the one or more available suppliers in an order based on the amount of matches between one or more parameters of the supplier information and one or more parameters of the order information.

22. The supply chain management system in accordance with claim 16, wherein the supply chain platform is configured to receive quality information associated with a specific product being supplied by the supplier and wherein the quality information comprises at least the compliance to the quality standards defined in the order information.

23. The supply chain management system in accordance with claim 22, wherein the supply chain management system further comprises a product certification database adapted to store compliance to quality standards, wherein the supply chain platform is configured to store compliance to the quality standards associated with each product supplied by the supplier within the product certification database.

24. The supply chain management system in accordance with claim 22, wherein the supply chain platform is further configured to present the quality information to the buyer device such that the buyer can determine if the supplier has adhered to defined quality standards.

25. The supply chain management system in accordance with claim 17, wherein the supply chain platform further configured to:
receive a status information from the supplier device at regular time intervals, wherein the status information is related to a product defined within the order details
process the status information to determine if any of the one or more predefined milestones has been achieved,
generate milestone information that comprises data related to any of the one or more predefined milestones has being achieved by the supplier,
provide the milestone information to the buyer device.

26. The supply chain management system in accordance with claim 16, wherein the system comprises an independent tester database, the independent tester database storing details of one or more independent testers and details of the tests the independent testers are qualified to perform,
the supply chain platform comprises a quality assurance engine arranged in electronic communication with the processor unit and/or the memory unit,
the supply chain platform or the quality assurance engine being configured to:
receive details of an independent tester and a test request, the test request defining one or more standards that a product from a supplier should adhere to,
provide the test request to an independent tester device associated with the independent tester,
provide the supplier device with details of the independent tester.

27. The supply chain management system in accordance with claim 26, wherein the supply chain platform or the quality assurance engine configured to process the test request, and provide a list of independent testers to the buyer device wherein the list of independent testers is compiled from the database of independent testers.

28. The supply chain management system in accordance with claim 27, wherein the supply chain platform or quality assurance engine configured to select independent testers for the list are selected based on if the independent tests can test for one or more standards defined in the test request.

29. The supply chain management system in accordance with claim 26, wherein the supply chain platform or quality assurance engine being configured to receive test results from the supplier device following testing executed by the independent tester and provide the test results to the buyer device.

30. The supply chain management system in accordance with claim 16, wherein the supply chain platform is configured to create a compliance profile for each supplier, wherein the compliance profile comprises one or more compliance certificates.

31. The supply chain management system in accordance with claim 16, wherein the supply chain platform comprises a communication unit, the communication unit is arranged in electronic communication with at least the processor unit such that processor unit controls operation of the communication unit based on a computer readable instructions executed by the processor unit and the communication unit being configured to send and receive electronic messages over a wireless communication network.

32. The supply chain management system in accordance with claim 16, wherein the supply chain platform comprises a server including the at least one hardware processor unit and the memory unit, wherein supply chain platform is configured to wirelessly communicate with the buyer devices and supplier devices via a suitable wireless communication network, and wherein the supply chain platform is arranged in a server client relationship with the buyer devices and the supplier devices, such that the supply chain platform functions as the server.

33. The supply chain management system in accordance with claim 16, wherein the supply chain platform is implemented in a cloud computing system, the cloud computing system comprising a plurality of interconnected servers or computing devices.

34. The supply chain management system in accordance with claim 16, wherein the supply chain platform further comprises;
a shipment engine arranged in electronic communication with the processor unit and/or the memory unit,
the shipment engine configured to process shipping information and store shipping information in a shipping database, the shipment engine further configured to communicate with a shipping company and track the location of a product being shipped, and the shipment engine configured to provide the location of the product to the user device at predetermined time intervals.
